(19) United States
(12) Patent Application Publication
(10) Pub. No.: US 2025/0347310 A1
(43) Pub. Date: Nov. 13, 2025

(54) Zero Gravity Fastener

(71) Applicant: Micheal Shane Perry, Mooresville, NC (US)

(72) Inventor: Micheal Shane Perry, Mooresville, NC (US)

(21) Appl. No.: 19/198,122

(22) Filed: May 5, 2025

Related U.S. Application Data
(60) Provisional application No. 63/643,777, filed on May 7, 2024.

(51) Int. Cl. F16B 23/00

(52) U.S. Cl. CPC F16B 23/0046

(57) ABSTRACT

A device is provided that relates generally to fastener heads for enhancing the ability to hold the fastener to the tool for application without using a magnetic tip on the tool and allowing for more facets in the fastener head into which the bit is keyed allowing for greater torque to be applied to the fastener head and allowing for a pulling pressure to be applied to the fastener while twisting or torquing the fastener. This ability to apply pulling force will allow for the bit to pull materials together and for the application of greater torque and pressure in a zero-gravity environment.

### CROSS-REFERENCE TO RELATED APPLICATIONS

This patent application claims the benefit of, and priority to, Provisional Application #63/643,777, filed on May 7, 2024, and titled “Zero Gravity Fastener,” by the same inventor/applicant, Micheal Shane Perry of Mooresville, North Carolina. The contents of Provisional Application #63/643,777 are incorporated in its entirety herein by reference.

### TECHNOLOGICAL FIELD

Embodiments of the present invention relate generally to fastener heads for enhancing the ability to hold the fastener to the tool for application without using a magnetic tool and allowing for more facets in the machine head into which the tool is keyed allowing for greater torque to be applied to the fastener head and allowing for a pulling pressure to be applied to the fastener while twisting or torquing the fastener. The ability to apply a pulling pressure to the bit is unique in that, among other functions, materials can be pulled together while being fastened and pressure can be applied to the threads in a zero-gravity environment.

### BACKGROUND

A typical fastener head is slotted to allow a tool to apply torque to the facets of the slot machined into the head of the fastener.

Manufacturers have designed many configurations of these facets to allow greater torque to be applied to the facets in the head of the fastener slot.

Problems arise when the tool slips from the fastener head slot, or the tool is not able to apply sufficient torque to the fastener head for the specifications required.

On many tools the tip of the tool is magnetized to allow the fastener to cling to the tool by magnetic force until the fastener is applied to the material to be fastened.

In this way the user can apply the fastener to the material to be fastened with one hand or at a distance where the user may not be able to physically reach, but which can be reached by extension.

This method will not function in an environment where the tool is impacted by external forces and the energy applied to the tool overcomes the magnetic force and the fastener is shaken off the tool.

This method allows the fastener to deflect prior to application such that it is no longer aligned properly for application.

This method does not function on non-ferrous fasteners that are not attracted magnetically.

This method does not function in an environment where a magnetic tool might damage or otherwise affect the material or being fastened or other components close to the site where the fastener is to be applied, such as sensitive electronic devices.

This method does not function well in an environment where the location for the fastener to be applied has other ferrous components that would attract the magnetic tip of the tool.

This method does not allow the use of a pulling force while applying the fastener.

This method does not work well in a zero-gravity environment.

Accordingly, there is a need for a fastener that will attach to a tool that is keyed in a way that the fastener will adhere to the non-magnetic tool without being shaken off the tool, which will be perfectly aligned for application, which will function well in a zero-gravity environment, and which allows for a pulling force to be applied to the fastener during application of the fastener to the fastened material.

### BRIEF SUMMARY

Through applied ingenuity, the inventor has developed a fastener head and congruent tool that will allow the fastener head to be temporarily connected to the tool in a way that the fastener will not be shaken from the tool, a magnetic tool is not required and the user can apply a pulling force on the fastener.

In particular, embodiments of a keyed fastener head are described herein, wherein the device comprises a device for fastening materials, a body defining a slotted fastener head for fasteners such as a bolt or screw with a reverse chamfer or other shape, a shaped slot designed to lock the bit into the fastener head while twisting or torquing, a slot through the head of the fastener configured to receive a bit used to twist or torque the fastener. a bit designed specifically to fit the contours of the fastener head. Wherein the body further defines a flat outer edge of the fastener head configured to allow ease of aligning the bit with the slot in the fastener head. The device wherein the body comprises metal.

A fastener comprising a head portion defining a surface, and a slot defined through the surface and extending at least partially through the head portion; and a stem portion connected to the head portion, wherein the stem portion defines a longitudinal axis, and wherein, upon installation of the apparatus, the stem portion is configured to engage at least one article, wherein the slot defines a first width proximate the surface of the head portion and a second width distal from the surface of the head portion, wherein the first width is smaller than the second width, and wherein the slot is configured to slidably receive an installation tool in a first direction transverse to the longitudinal axis so as to form a locking engagement with the installation tool in a second direction parallel to the longitudinal axis.

In some cases, the device may be configured to have a flattened surface on both ends of the slot to ease alignment of the bit with the slot.

In some cases, the body further defines a flat outer edge of the fastener head configured to allow ease of aligning the tool with the slot in the fastener head.

In some embodiments the fastener will consist of material that is hard enough to not deform tool when tightened to specifications for the fastener's purpose.

In some embodiments, the body comprises metal.

In some embodiments, the body comprises ceramic. In some embodiments, the body comprises gemstone.

An installation tool for installing a fastener, the installation tool comprising an engagement end defining a longitudinal axis; and an operating end connected to the engagement end and configured to be grasped by a user for manipulating the engagement end, wherein the engagement end defines a tip having a first diameter proximate an outermost point of the tip and a second diameter distal from the outermost point of the tip, wherein the first diameter is larger than the second diameter, wherein the tip is configured to be slidably received by a fastener in a first direction transverse to the longitudinal axis so as to form a locking engagement with the fastener in a second direction parallel to the longitudinal axis.

Where a tool that is keyed to fit the fastener is not available, a typical flat tipped tool will function on the fastener allowing for greater flexibility in its use.

In some embodiments, the keyed surfaces will comprise various configurations of reverse chamfer or curve which may allow for specific amounts of torque or other specific tolerances to by applied.

In some embodiments the tool and slot will fit with a tolerance that allows for the function of the tool and fastener in combination, but with loose enough tolerance that the tool will not become fixed in the head of the fastener.

In some embodiments the tool will consist of material that is hard enough to not deform the fastener when tightened to specifications for the fastener's purpose.

In some embodiments, the body comprises metal.

In some embodiments, the body comprises ceramic.

In some embodiments, the body comprises gemstone.

### BRIEF DESCRIPTION OF THE DRAWINGS

Having thus described the disclosure in general terms, reference will now be made to the accompanying drawings, which are not necessarily drawn to scale. The components illustrated in the figures may or may not be present in certain embodiments described herein. Some embodiments may include fewer (or more) components than those shown in the figures.

FIG. 1 illustrates a schematic representation of the fastener and the tool with illustrations of the side view of the tool and the fastener and top view of two variations of the fastener;

FIG. 2 illustrates a schematic representation of a variation of the tool that is machined to fit into the slot machined into the head of the fastener;

FIG. 3 illustrates a schematic representation of a variation of the tool that is machined to fit into the slot machined into the head of the fastener;

FIG. 4 illustrates a schematic representation of a variation of the tool that is machined to fit into the slot machined into the head of the fastener;

FIG. 5 illustrates a schematic representation of a variation of the tool that is machined to fit into the slot machined into the head of the fastener;

FIG. 6 illustrates a schematic representation of a variation of the tool that is machined to fit into the slot machined into the head of the fastener;

FIG. 7 illustrates a schematic representation of a variation of the tool that is machined to fit into the slot machined into the head of the fastener;

FIG. 8 illustrates a schematic representation of a variation of the head of the fastener;

### DETAILED DESCRIPTION

Example embodiments will now be described more fully hereinafter with reference to the accompanying drawings, in which some, but not all, embodiments are shown. Indeed, the embodiments may take many different forms and should not be construed as limited to the embodiments set forth herein; rather, these embodiments are provided so that this disclosure will satisfy applicable legal requirements. Like reference numerals refer to like elements throughout. The terms “exemplary” and “example” as may be used herein are not provided to convey any qualitative assessment, but instead merely to convey an illustration of an example. As used herein, terms such as “front,” “rear,” “top,” “bottom,” “inside,” “outside,” “inner,” “outer,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances. Thus, use of any such terms should not be taken to limit the spirit and scope of embodiments of the present invention.

As noted above, a typical fastener head, for example, a screw or a bolt, is slotted to allow a tool to apply torque to the facets of the slot machined into the head of the fastener. Manufacturers have designed many configurations of these facets to allow greater torque to be applied to the facets in the head of the fastener slot.

Problems arise when the tool slips from the fastener head slot, the tool is not able to apply sufficient torque to the fastener head for the specifications required, or the user cannot use both hands to hold the fastener to the tool during application. Also, the slot can be deformed (stripped), which can prevent or at least hinder subsequent engagement with the tool.

In particular, the tool tends to slip from the facets of the fastener head because the tool cannot be secured to the fastener head in current configurations of tool and fastener without either magnetism, adhesive, or a complex and delicate mechanism which typically gets in the way of the work being performed and does not function well.

As noted above, on many tools the tip of the tool is magnetized to allow the fastener to cling to the tool by magnetic force until the fastener is applied to the material to be fastened. In this way the user can apply the fastener to the material to be fastened with one hand or at a distance where the user may not be able to physically reach, but which can be reached by extension.

The magnetized tool method will not function in an environment where the tool is impacted by external forces and the energy applied to the tool overcomes the magnetic force and the fastener is shaken off the tool. Such a method allows the fastener to deflect prior to application such that it is no longer aligned properly for application. Such a method does not function on non-ferrous fasteners that are not attracted magnetically. Such a method does not function in an environment where a magnetic tool might damage or otherwise affect the material or being fastened or other components close to the site where the fastener is to be applied, such as sensitive electronic devices. Such a method does not function well in an environment where the location for the fastener to be applied has other ferrous components that would attract the magnetic tip of the tool.

Such a method does not allow the use of a pulling force while applying the fastener.

Accordingly, there is a need for a fastener that will attach to a tool that is keyed in a way that the fastener will adhere to the non-magnetic tool without being shaken off the tool, which will assist in alignment for application, which will function well in a zero-gravity environment, and which allows for a pulling force to be applied to the fastener during application of the fastener to the fastened material.

In particular, embodiment of the present invention provides a device that relates generally to fastener heads for enhancing the ability to hold the fastener to the tool for application without using magnetism and allowing for more facets in the machine head into which the tool is keyed allowing for greater torque to be applied to the fastener head and allowing for a pulling pressure to be applied to the fastener while twisting or torquing the fastener.

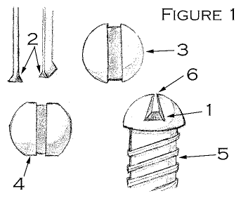

Embodiments of the device include a fastener comprising: a head portion 3 (FIG. 1) defining: a surface 3 (FIG. 1), and a slot 1 (FIG. 1) defined through the surface and extending at least partially through the head portion; and a stem portion 5 (FIG. 1) connected to the head portion, wherein the stem portion defines a longitudinal axis, and wherein, upon installation of the apparatus, the stem portion is configured to engage at least one article, wherein the slot defines a “reverse chamfer” wherein a first width proximate the surface of the head portion 6 (FIG. 1), and a second width distal from the surface of the head portion 1 (FIG. 1), wherein the first width is smaller than the second width, and wherein the slot is configured to slidably receive an installation tool in a first direction transverse to the longitudinal axis so as to form a locking engagement with the installation tool in a second direction parallel to the longitudinal axis.

In some embodiments the slot 1 (FIG. 1) is machined so that it will accept a flat-tipped tool applied from the top of the fastener head 3 (FIG. 1).

In some embodiments, the fastener head is machined flat at both ends of the slot 4 (FIG. 1) to assist the process of fitting the tool into the slot.

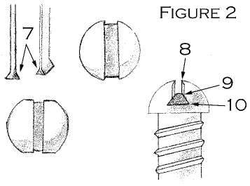

In some embodiments there will be variations of the tool 7 (FIG. 2) that is machined to fit into the slot 8 (FIG. 2) of the fastener head, so that the reverse-chamfer, as defined in [0050], and wherein a first width proximate the surface of the head portion 8 (FIG. 2), a second width distal to the surface of the head portion 9 (FIG. 2) and a third width 10 (FIG. 2) distal from the second width, wherein the first and second widths are equal widths and smaller than the third width machined deeper in the fastener head 9 (FIG. 2).

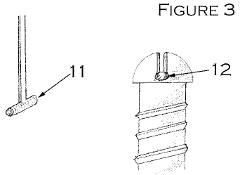

In some embodiments there will be variations of the tool 11 (FIG. 3) that is machined to fit into the slot 12 (FIG. 3) of the fastener head, so that the tip of the tool 11 (FIG. 3) is generally cylindrical at some point on the shaft of the tool to fit into a generally cylindrical slot 12 (FIG. 3) machined into the fastener head.

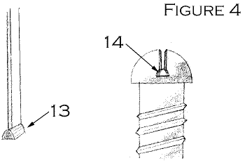

In some embodiments there will be variations of the tool 13 (FIG. 4) that is machined to fit into the slot 14 (FIG. 4) of the fastener head, so that the tip of the tool 13 (FIG. 4) is generally semi-cylindrical to fit into a generally semi-cylindrical slot 14 (FIG. 4) machined into the fastener head.

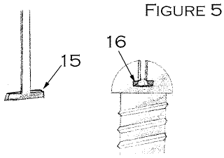

In some embodiments there will be variations of the tool 15 (FIG. 5) that is machined to fit into the slot 16 (FIG. 5) of the fastener head, so that the tip of the tool 15 (FIG. 5) is generally cuboid at some point on the shaft of the tool to fit into a generally cuboid slot 16 (FIG. 5) machined into the fastener head.

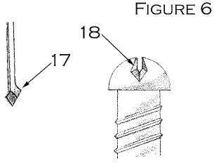

In some embodiments there will be variations of the tool 17 (FIG. 6) that is machined to fit into the slot 18 (FIG. 6) of the fastener head, so that the tip of the tool 17 (FIG. 6) is generally diamond shaped at some point on the shaft of the tool to fit into a generally diamond-shaped slot 18 (FIG. 6) machined into the fastener head. This allows for more facets to which torque may be applied.

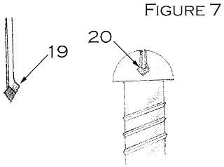

In some embodiments there will be variations of the tool 19 (FIG. 7) that is machined to fit into the slot 20 (FIG. 7) of the fastener head, so that the diamond-shape of the slot is machined deeper in the fastener head 20 (FIG. 7) similar as described in but with a diamond shaped slot and tool.

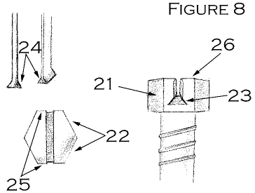

In some embodiments there will be variations of the fastener head 21 (FIG. 8) so that it is machined to have facets that fit into a socket 22 (FIG. 8) in a bolt-head configuration, yet still have a variation of the machined lateral slot in the fastener head 23 (FIG. 8), so that the congruently-machined tool 24 (FIG. 8) will also fit as designed.

In some embodiments, the bolt-head variation of the fastener is machined flat at both ends of the slot 25 (FIG. 8) to assist the process of fitting the tool into the slot.

In some embodiments, the bolt head is machined flat on top 26 (FIG. 8).

The device can be designed so that the machined shape of the tool fits deeper or shallower in the fastener head.

The invention claimed is:

1. A fastener comprising:
a head portion defining:
a surface, and
a slot defined through the surface and extending at least partially through the head portion; and
a stem portion connected to the head portion, wherein the stem portion defines a longitudinal axis, and wherein, upon installation of the apparatus, the stem portion is configured to engage at least one article,
wherein the slot defines a first width proximate the surface of the head portion and a second width distal from the surface of the head portion,
wherein the first width is smaller than the second width, and
wherein the slot is configured to slidably receive an installation tool in a first direction transverse to the longitudinal axis so as to form a locking engagement with the installation tool in a second direction parallel to the longitudinal axis.

2. The fastener of claim 1, wherein the surface of the head portion is flat, thereby facilitating alignment of a bit with the slot.

3. The fastener of claim 1, wherein at least one of the head portion or the stem portion comprises metal.

4. The fastener of claim 1, wherein at least one of the head portion or the stem portion comprises a ceramic material.

5. The fastener of claim 1, wherein at least one of the head portion or the stem portion comprises a mineral or gemstone.

6. An installation tool for installing a fastener, the installation tool comprising:
an engagement end defining a longitudinal axis; and
an operating end connected to the engagement end and configured to be grasped by a user for manipulating the engagement end,
wherein the engagement end defines a tip having a first diameter proximate an outermost point of the tip and a second diameter distal from the outermost point of the tip,
wherein the first diameter is larger than the second diameter,
wherein the tip is configured to be slidably received by a fastener in a first direction transverse to the longitudinal axis so as to form a locking engagement with the fastener in a second direction parallel to the longitudinal axis.

7. The installation tool of claim 6, wherein the engagement end comprises metal.

8. The installation tool of claim 6, wherein the engagement end comprises a ceramic material.

9. The installation tool of claim 6, wherein the engagement end comprises a mineral or a gemstone.

10. A fastening system comprising:
a fastener comprising:
a head portion defining:
a surface, and
a slot defined through the surface and extending at least partially through the head portion; and
a stem portion connected to the head portion, wherein, upon installation of the fastener, the stem portion is configured to engage at least one article,
wherein the slot defines a first width proximate the surface of the head portion and a second width distal from the surface of the head portion, and
wherein the first width of the slot is smaller than the second width of the slot; and
an installation tool for installing the fastener, the installation tool comprising:
an engagement end defining a longitudinal axis; and
an operating end connected to the engagement end and configured to be grasped by a user for manipulating the engagement end,
wherein the engagement end defines a tip having a first diameter proximate an outermost point of the tip and a second diameter distal from the outermost point of the tip,
wherein the first diameter of the engagement end is larger than the second diameter of the engagement end,
wherein the tip is configured to be slidably received within the slot of the head portion of the fastener in a first direction transverse to the longitudinal axis of the engagement end so as to form a locking engagement with the fastener in a second direction parallel to the longitudinal axis.

11. The fastening system of claim 10, wherein the surface of the head portion of the fastener is flat, thereby facilitating alignment of the tip of the engagement end of the installation tool with the slot.

12. The fastening system of claim 10, wherein at least one of the head portion or the stem portion of the fastener comprises metal.

13. The fastening system of claim 10, wherein at least one of the head portion or the stem portion of the fastener comprises a ceramic material.

14. The fastening system of claim 10, wherein at least one of the head portion or the stem portion of the fastener comprises a mineral or gemstone.

15. The fastening system of claim 10, wherein the engagement end of the installation tool comprises metal.

16. The fastening system of claim 10, wherein the engagement end of the installation tool comprises a ceramic material.

17. The fastening system of claim 10, wherein the engagement end of the installation tool comprises a mineral or a gemstone.
